(19) United States
(12) Patent Application Publication
(10) Pub. No.: US 2006/0061514 A1
(43) Pub. Date: Mar. 23, 2006

(54) Broadband symmetrical dipole array antenna

(75) Inventor: Chun-Chien Chien, Dasi Township (TW)

Correspondence Address: Welsh & Katz, Ltd.;Eric D. Cohen, 22nd Floor, 120 South Riverside Plaza, Chicago, IL, 60606, US

(73) Assignee: SmartAnt Telecom Co. Ltd., Hsinchu (TW)

(21) Appl. No.: 10/947,759

(22) Filed: Sep. 23, 2004

(51) Int. Cl. H01Q 9/28

(52) U.S. Cl. 343/795; 343/816

(57) ABSTRACT

A broadband symmetrical dipole array antenna adopted for use in radio transmission includes a symmetrical feed network, symmetrical radiation units and a reflection plate. The symmetrical feed network and the symmetrical radiation units form an antenna field of a narrower radiation angle range. The reflection plate is spaced from one side of the antenna in a parallel fashion at a selected distance to reflect the radiation signals and enhance antenna directionality.

### FIELD OF THE INVENTION

The invention relates to a broadband symmetrical dipole array antenna adopted for used on electronic devices to perform radio transmission, and particularly a broadband symmetrical dipole array antenna that is equipped with a reflection plate.

### BACKGROUND OF THE INVENTION

With continuous advances in the wireless communication industry, users can transmit information through radio transmission systems without geographical restrictions. The antenna is an important element in such radio transmission systems. It transforms the voltage and current of a transmitter into electromagnetic waves and broadcasts them in radiation fashion. The electromagnetic waves may also be received and transformed to voltage and current, and transferred to a receiver for processing to accomplish signal transmission. Commonly used antennas include dipole antennas, helical antennas, and the like.

While radio transmission is relatively free from geographical restrictions, when the antenna is installed on a location with geographical obstacles (such as corners of walls, ceiling, etc.), its directional gain drops, and the communication quality of signal transmission and reception suffers. To remedy this problem, a common approach has been to install a reflection plate on one side of the antenna to enhance the directionality of the antenna, boost the directional gain and improve communication quality.

The structure and shape of the reflection plate affect the directional gain. The most commonly used reflection plate has an opening to improve directionality. In order to accommodate the size of the reflection plate, a larger shell is needed to encase the antenna base-board and the reflection plate. Such a design does not fit the prevailing trend that demands slim and light. Hence to balance the improvement of antenna directionality with the size of the antenna has become an urgent issue to be resolved.

Refer to FIG. 1 for a conventional antenna 10 that adopts a parallel-series feed design. Such a design is applicable only in a selected and narrow frequency spectrum (such as 4.9˜5.0 GHz, U-NII-One/Two 5.15˜5.35 GHz, U-NII-Three 5.725˜5.875 GHz). It cannot be used with radio communication that covers multiple frequency spectrums (such as 4.9˜5.875 GHz). In such a situation, two or more antennas have to be used. Hence increasing the antenna transmission bandwidth to free users from procuring additional antennas also is an issue that needs to be addressed.

### SUMMARY OF THE INVENTION

In view of the aforesaid problems occurring with the conventional techniques, the invention aims to provide a broadband symmetrical dipole array antenna that has a parallel reflection plate to reflect the antenna radiation signal and enhance the directionality of the antenna.

In order to achieve the foregoing object, the broadband symmetrical dipole array antenna according to the invention includes a symmetrical feed network, symmetrical radiation units and a reflection plate. The symmetrical feed network has a zigzag circuit path to increase the transmission bandwidth. The symmetrical radiation units can generate radiation signals of a smaller radiation angle to enhance directionality. The reflection plate is located on one side of the antenna in a parallel manner to reflect the radiation signals in a selected direction and increase the directional gain of the array antenna.

The antenna with the feed network formed in a symmetrical zigzag circuit not only increases the transmission bandwidth, but also shrinks the radiation angle of the radiation signals to enhance directionality. The reflection plate can also boost the directional gain. Therefore the transmission bandwidth and directionality of the array antenna are improved.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of the feed network of a conventional Parallel-Series Feed antenna;

FIG. 2 is an exploded view of the antenna of the invention;

FIG. 3 is a perspective view of the antenna of the invention after assembly;

FIG. 4A is a plain view of a first surface of the antenna base-board of the invention;

FIG. 4B is a plain view of a second surface of the antenna base-board of the invention;

FIG. 5A˜5C are a radiation field graphic of V-polarization according to the invention;

FIG. 6A˜6C are a radiation field graphic of H-polarization according to the invention; and

FIG. 7 is a chart of the measured voltage stationary wave ratios according to the invention.

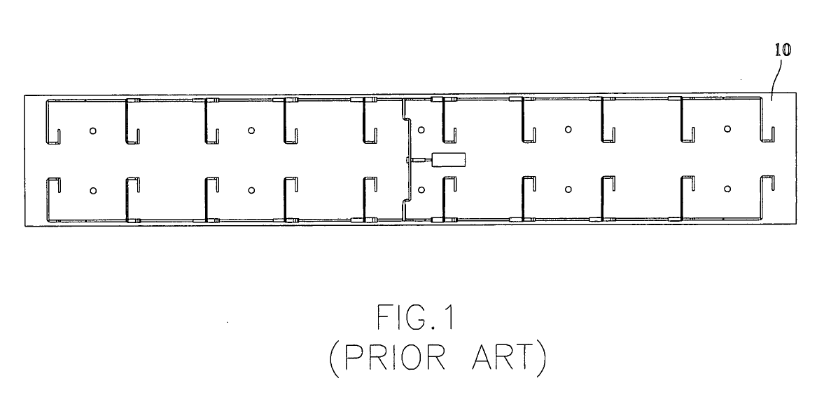

### DESCRIPTION OF THE PREFERRED EMBODIMENT

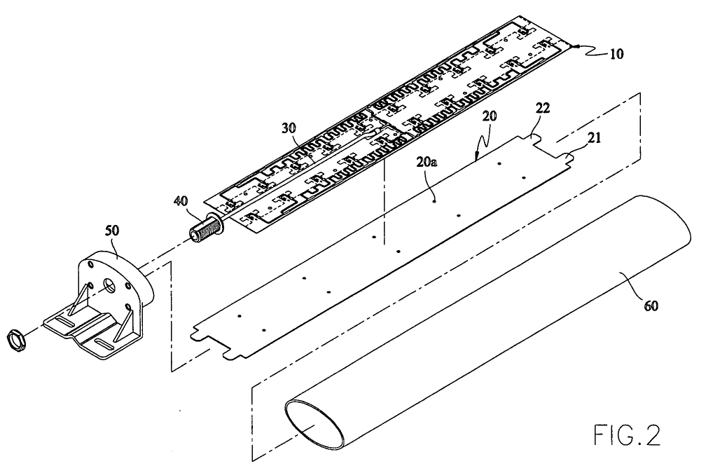

Referring to FIG. 2, the antenna according to the invention includes an antenna 10, a reflection plate 20, a metal conductive wire 30, a connector 40, a seat 50 and a shell 60. The reflector 20 is spaced from one side of the antenna 10 in a parallel manner at a selected distance. The antenna 10 is a printed circuit antenna made from non-metallic material (such as Rogers RO-4350B). It has a first surface 101 and a second surface 102 formed with a required circuit pattern by chemical etching.

The reflection plate 20 has lugs 21 and 22 extended from two ends to wedge in slots formed on the seat 50 and the shell 60 and anchor thereon. The reflection plate 20 is flat and about the size of the antenna 10. It is made of metal that has a shielding effect upon electromagnetic waves, and can therefore reflect radiation signals generated by the antenna 10 in a selected direction to boost the directional gain of the antenna.

The seat 50 is formed substantially in an L-shape to anchor on a bracing rack (not shown in the drawing) and house the connector 40. The connector 40 has one end connecting to a signal feeding point 11 of the antenna 10 through the metal conductive wire 30, and another end connecting to an electronic device (not shown in the drawing).

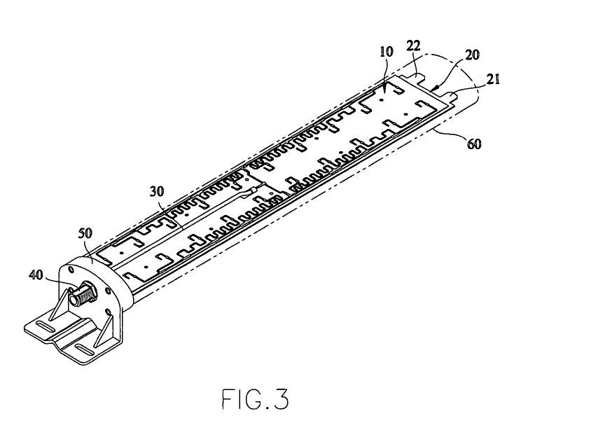

The shell 60 is coupled with the seat 50 to encase the antenna 10 and the reflection plate 20 to provide protection. Refer to FIG. 3, the shell 60 and the seat 50 form a sealed body to cover the antenna 10 and the reflection plate 20.

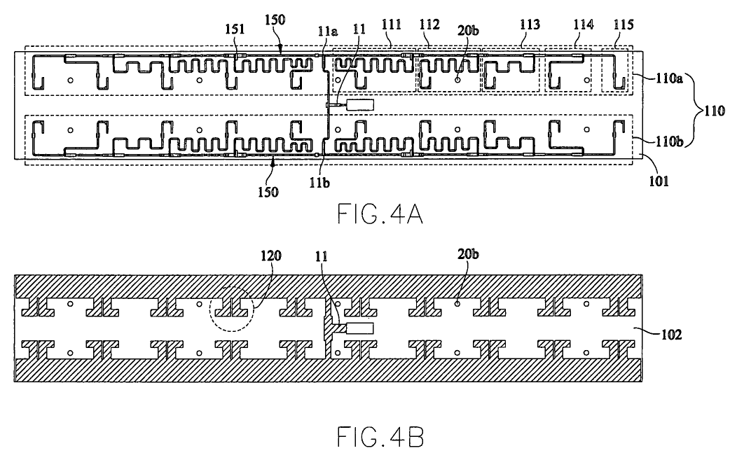

Refer to FIG. 4A for the first surface of the antenna base-board. The first surface 101 has a symmetrical feed network 110, which includes a signal feeding point 11 to serve as the center of a first feed network 110a and a second feed network 110b, which are symmetrical.

It also has a first branch point 1 la that serves as the center of a first feeding unit 111, a second feeding unit 112, a third feeding unit 113, a fourth feeding unit 114, and a fifth feeding unit 115, which are formed symmetrically on the left side and the right side to become the first feed network 110a. The second feed network 110b is located on another side of the antenna 10 and is symmetrical to the first feed network 110a. Each feeding unit has a different zigzag circuit, is extended towards two sides of the antenna 10 in a zigzag manner with a decreasing zigzag path from the first branch point 11a and a second branch point 11b, and is jointly connected to a transmission bus 150. The zigzag path forms the same phase from the signal feeding point 11 to each radiation unit 120 to increase transmission bandwidth. Moreover, each branch point of the transmission bus 150 is coupled with an impedance matching section 151 to match the required impedance of the circuit.

Refer to FIG. 4B for the second surface of the antenna base-board. The symmetrical radiation units 120 are located on the second surface 102. They are centered on the signal feeding point 11 and laid symmetrically on the left side and the right side to couple with the signals of the feed network, and transmit the signals by radiation. Each radiation unit 120 is substantially formed in a T-shape. The signals radiated in the direction of the horizontal ends of the T-shaped structure are wider than those of the vertical end, and thus have a more desirable directionality. When laying in a parallel manner, directionality improves. Also, each corresponds to a feeding unit. The symmetrical layout can reduce the radiation angle of the radiated signals (for instance, reducing from 120 degrees to 60 degrees). This can also boost the directional gain of the radio signals.

The reflection plate 20 is spaced from one side of the antenna 10 in a parallel manner at a selected distance. It has lugs 21 and 22 extended from two ends to wedge in the slots formed on the seat 50 and the shell 60 and anchor thereon. The reflection plate 20 is flat and about the size of the antenna 10. It is made of metal such as aluminum, iron or stainless steel that has a shielding effect upon electromagnetic waves, and can therefore reflect the radiation signals generated by the antenna 10 in a selected direction and boost the directional gain of the antenna.

The reflection plate 20 further has a plurality of first apertures 20a. The antenna 10 also has a plurality of second apertures 20b corresponding to the first apertures 20a. The apertures are coupled by fastening elements (such as plastic rivets, nails, plastic screws, and the like) to fasten the reflection plate 20 and the antenna 10.

In addition, the invention may conform to IEEE (Institute of Electrical and Electronic Engineers) 802.11a communication protocols. By fine-tuning the distance of the symmetrical feed network 110, the symmetrical radiation units 120 and the elevation of the reflection plate 20, the invention may be used within frequency spectrums ranging from 4.9 GHz to 5.875 GHz.

The symmetrical dipole array antenna thus constructed, besides employing the symmetrical antenna circuit to increase the transmission bandwidth, also can reduce the radiation angle of the radiation signals and improve directionality. The reflection plate can increase directional gain. Thus both the transmission bandwidth and directionality are improved. Also, the zigzag circuit design of the feed network allows the broadband antenna to achieve an even wider transmission bandwidth.

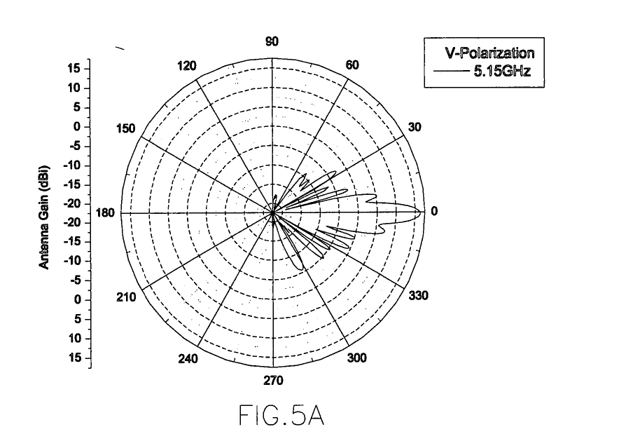

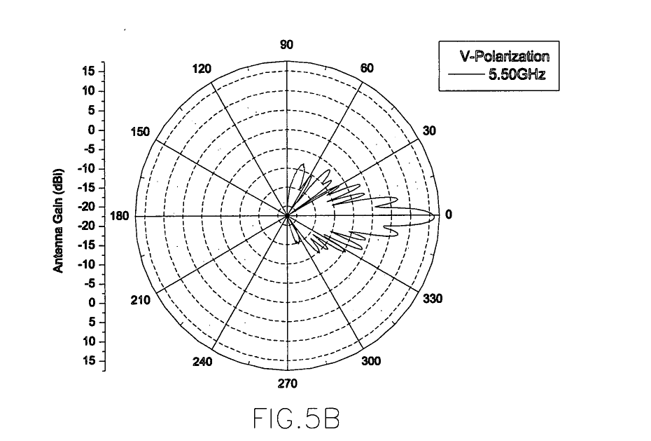

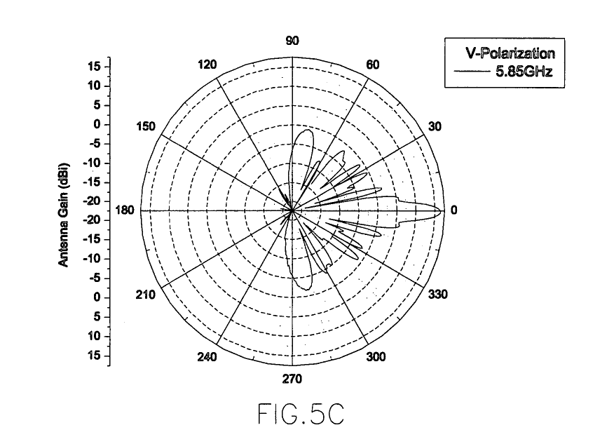

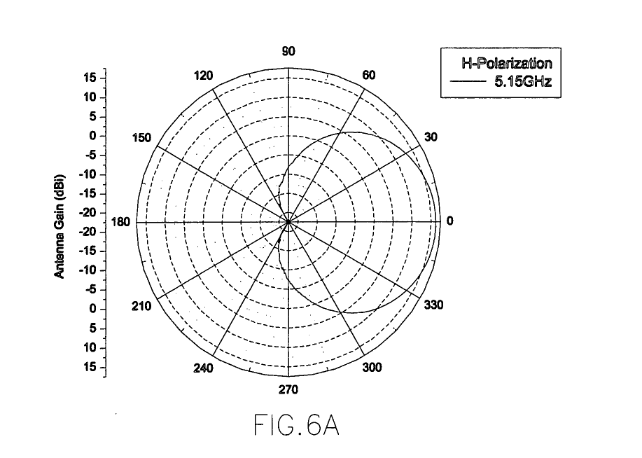

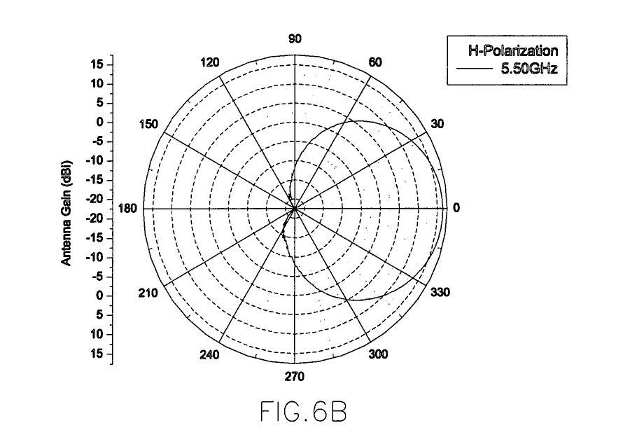

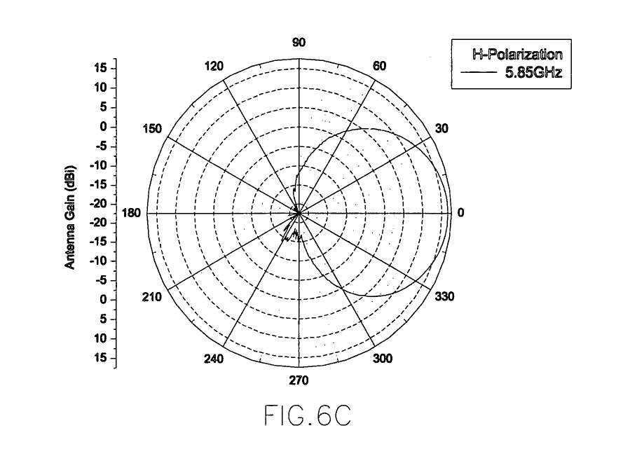

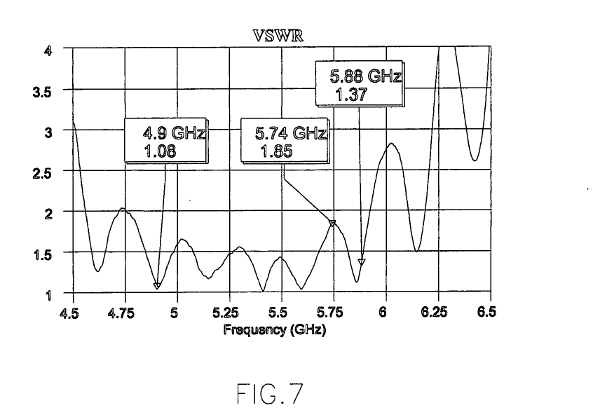

Actual tests of the invention have been conducted based on frequencies 5.15 GHz, 5.50 GHz, and 5.85 GHz. The results are indicated in radiation field graphics and a voltage stationary wave ratio test chart as follows. FIG. 5A˜5C are the radiation field graphic of V-polarization. FIG. 6A˜6C are the radiation field graphic of H-polarization. FIG. 7 is the chart of the measured voltage stationary wave ratios with the frequency in the range of 4.50 GHz˜6.50 GHz.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A broadband symmetrical dipole array antenna located on a base board which has a first surface and a second surface, comprising:
a symmetrical feed network located on the first surface consisting of a plurality of feeding units laid in a symmetrical fashion to increase transmission bandwidth;
a plurality of radiation units located on the second surface and laid in a symmetrical fashion to couple with signals of the feed network and to radiate corresponding radiation signals and shrink the radiation angle of the radiation signals through the symmetrical layout structure; and
a reflection plate spaced from one side of the antenna in a parallel fashion at a selected distance and made of metal to reflect the radiation signals and enhance the directionality of the antenna.

2. The broadband symmetrical dipole array antenna of claim 1, wherein the feeding units have zigzag circuits.

3. The broadband symmetrical dipole array antenna of claim 1, wherein the feeding units have a branch point coupled with an impedance matching section to match the impedance required by the antenna circuits.

4. The broadband symmetrical dipole array antenna of claim 1, wherein the radiation unit is substantially formed in T-shape.

5. The broadband symmetrical dipole array antenna of claim 1, wherein the antenna is a printed circuit antenna.

6. The broadband symmetrical dipole array antenna of claim 1, wherein the base board is made from Rogers RO-4350B.

7. The broadband symmetrical dipole array antenna of claim 1, wherein the antenna and the reflection plate are housed in a shell to be protected thereof.

8. The broadband symmetrical dipole array antenna of claim 1, wherein the reflection plate has a plurality of apertures to couple with fastening elements to fasten the antenna to the reflection plate.

9. The broadband symmetrical dipole array antenna of claim 1, wherein the reflection plate has at least one lug on one end to wedge in a corresponding slot formed on a seat to anchor the reflection plate.

10. The broadband symmetrical dipole array antenna of claim 1, wherein the reflection plate is made of a material which includes aluminum.

11. The broadband symmetrical dipole array antenna of claim 1, wherein the reflection plate is made of a material which includes iron.

12. The broadband symmetrical dipole array antenna of claim 1, wherein the reflection plate is made of a material which includes stainless steel.

13. The broadband symmetrical dipole array antenna of claim 1, wherein the reflection plate is substantially formed in the size of the antenna.
